(19) United States
(12) Patent Application Publication
(10) Pub. No.: US 2011/0320715 A1
(43) Pub. Date: Dec. 29, 2011

(54) IDENTIFYING TRENDING CONTENT ITEMS USING CONTENT ITEM HISTOGRAMS

(75) Inventors: Steven W. Ickman, Snoqualmie, WA (US); Thomas M. Laird-McConnell, Kirkland, WA (US)

(73) Assignee: Microsoft Corporation, Redmond, WA (US)

(21) Appl. No.: 12/821,747

(22) Filed: Jun. 23, 2010

(51) Int. Cl. G06F 17/30; G06F 12/08

(52) U.S. Cl. 711/118; 707/748; 707/E17.009; 711/E12.017

(57) ABSTRACT

Within a content item set, particular content items may be identified as trending, based on changes in a frequency of references to the content items. For example, users of a social network may reference web resources by posting the uniform resource locators (URLs) thereof in messages, and trending web resources may be identified by detecting changes in the frequencies of such references. These trends may be tracked by counting such references in content item histograms, and by computing trend scores at the time of detecting each reference to a content item. Trending content items may then be identified at a second time by comparing the trend scores after decaying the trend scores of respective content items, based on the period between the second time and the last reference time of the last detected reference to the content item.

### BACKGROUND

Within the field of computing, many scenarios involve a set of content items that may be referenced by various agents. As a first example, users of a social network may post messages that include references (such as uniform resource locators, or URLs) to web resources, such as web pages, videos, and images. As a second example, such users may also post messages that include references to particular content items, such as URLs of various resources available on the web, or a geographic reference (such as global positioning system (GPS) coordinates) indicating a particular geographic location. As a third example, patrons of an e-commerce site may post messages referring to various products or service that may be available through the e-commerce site. In these and other scenarios, it may be desirable to identify content items that exhibit positively trending popularity and/or use. This information may be used, e.g., to present to a user a list of currently trending content items, to suggest trending content items to a user (e.g., a predictive text entry device may suggest the completion or correction of user input based on textual names of trending content items), or to allow e-commerce providers to adjust prices and supplies of products or services based on trends in demand.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While information about trending content items may be useful in many scenarios, identifying such trending content items may be difficult for various reasons. For example, it may be difficult to identify a particular content item included in a reference, which may involve conversational context, the disambiguation of ambiguous terms, and the interpretation of acronyms. Moreover, it may be difficult to evaluate such references in a voluminous set of messages, such as an entire set of messages posted by users of a social network, in a manner that efficiently but thoroughly evaluates each message in a prompt manner. For example, rapidly detecting a surge in references to a particular news article, such as may indicate breaking news, may be difficult to achieve if the volume of messages is large.

Presented herein are techniques for tracking references to various content items in a potentially efficient and scalable manner, which may support the rapid detection of trending content items even in an environment featuring a large volume of such references. These techniques involve the user of a set of content item histograms, each representing a different content item and comprising a set of measurements of references to the content item within different periods. For example, a content item histogram may comprise an array, where the first index (number 0) represents the references to the content item detected within a current time period, the second index (number 1) represents the references to the content item detected within a preceding time period, the third index (number 2) represents the references to the content item detected within a time period preceding that of the second index, etc.

When a new reference to the content item is detected, the current time may be compared with a last reference time for the content item histogram to determine whether the current measurement period has elapsed. If so, a new reference count (representing a new measurement period) may be added to the content item histogram (e.g., by inserting a new entry at the head of the array.) Additionally, a trend score may be computed for the content item based on the content item histogram indicating its trending popularity and/or use at the time of detecting the last detected reference to the content item. For example, a high trend score may be computed for a content item that has demonstrated a recent and sharp upswing in references, even if the number of references is comparatively low, while a low trend score may be computed for a content item that demonstrates a recent plateau or reduction in detected references, even if the number of references remains high (indicating steady but non-trending popularity in the content item.) When the content items are subsequently evaluated to determine the content items with trending popularity, the trend score of each content item may be decayed based on the time elapsed since the last detected reference, and the content items having the highest trend scores (after the decaying adjustment) may be selected as the content items having the sharpest upward trend in popularity. In this manner, the trending popularities may be identified in a comparatively efficient manner. Moreover, in some embodiments, a set of devices comprising a server set may evaluate different batches of references and update the content item histogram accordingly, thereby enabling a scalability of the evaluation that remains proportional to the volume of references evaluated (e.g., if the evaluation of references comprises a rate-limiting element of the technique, additional capacity and performance may be predictably and proportionally increased by adding new devices to the server set to evaluate additional groups of references.)

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a social network comprising users posting a set of messages having references to content items.

FIG. 2 is an illustration of an exemplary scenario featuring an identification of trending content items among a set of content items.

FIG. 3 is an illustration of an exemplary scenario featuring a tracking of references to various content items using a set of content item histograms according to the techniques presented herein.

FIG. 4 is an illustration of an exemplary scenario featuring an identification of trending content items among a set of content items according to the techniques presented herein.

FIG. 5 is a flowchart illustrating an exemplary method of identifying trending content items among a set of content items.

FIG. 6 is a component block diagram illustrating an exemplary system for identifying trending content items among a set of content items.

FIG. 7 is an illustration of an exemplary computer-readable medium comprising processor-executable instructions configured to embody one or more of the provisions set forth herein.

FIG. 8 is an illustration of an exemplary scenario featuring a generalization of location references to a set of generalized location references identifying a set of locations comprising content items.

FIG. 9 is an illustration of an exemplary scenario featuring a detection of content items indirectly referenced by redirecting references 122 and a caching thereof in a reference cache.

FIG. 10 is an illustration of an exemplary implementation of a content item histogram as an integer array.

FIG. 11 is another illustration of an exemplary implementation of a content item histogram as an integer array.

FIG. 12 is an illustration of an exemplary implementation of a set of content item histograms respectively representing the references to a content item over different reference periods.

FIG. 13 is an illustration of an exemplary scenario featuring a deterministic technique for decaying the trend scores of a set of content items.

FIG. 14 is an illustration of an exemplary scenario featuring two techniques for presentation trending content items to a user.

FIG. 15 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a tracking of the trending popularity and use of a set of content items through the detection of references to the content items generated by various agents (such as users, but also including software processes.) For example, in a social network, users may author messages, including publicly accessible posts and private messages directed to particular other users, that include references to various content items, such as uniform resource locators (URLs) identifying web pages containing a particular story or content item. In this and other scenarios, the tracking of trends in the frequency of references to the content items may be advantageous. By contrast with content items that are not “trendingly” referenced (e.g., referenced with a significantly different frequency than at a previous time point) but that are simply often referenced (e.g., popular content items, such as frequently visited websites, or often-referenced locations), the identification of trends in the frequency of references may be distinctively useful. As a first example, a commercial enterprise may maintain inventory of various products based on predictions of stable demand (e.g., maintaining a high volume of inventory of frequently purchased products and a low volume of inventory of infrequently purchased products), but may also wish to identify dynamic trends in the frequency of such purchases in order to adjust the set of products available for purchase. As a second example, a media library may track the popularity of various media items, but may separately track trends in such popularity (e.g., in order to suggest to a user media items that other users have frequently begun playing often.)

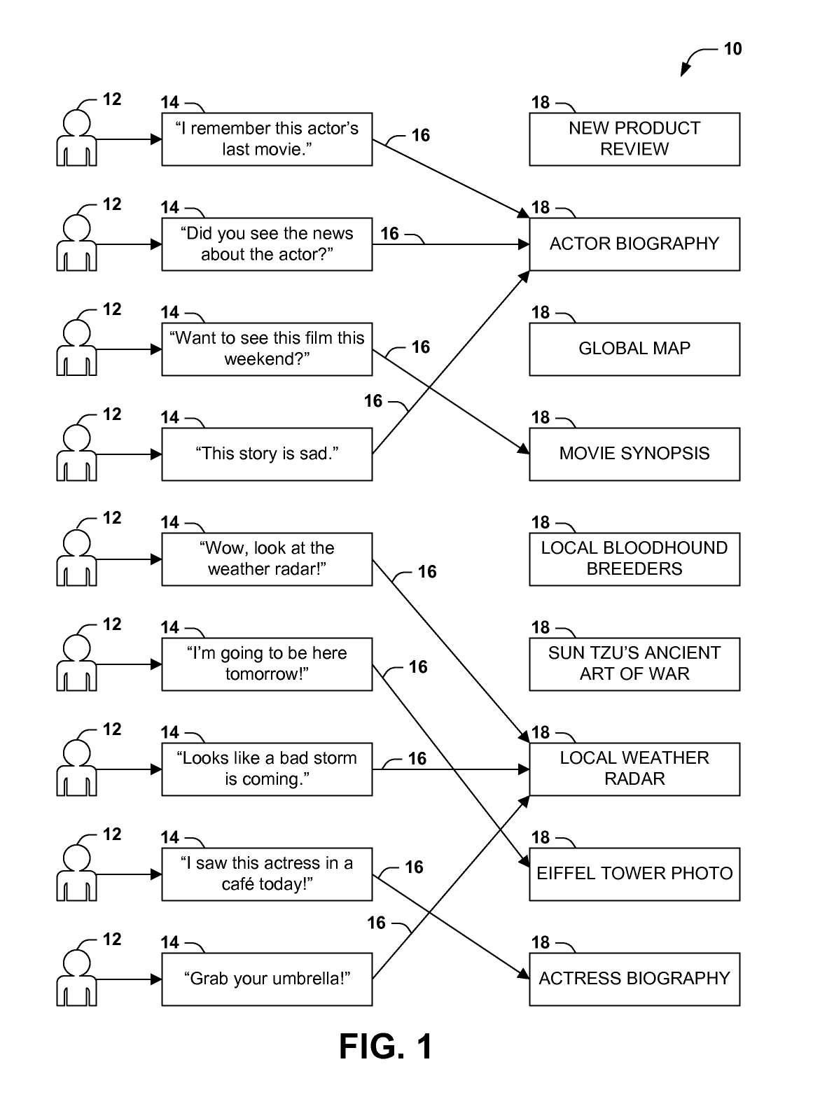

FIG. 1 presents an exemplary scenario 10 featuring a trend in the popularity of content items 18, based on references 16 to such content items 18 in messages 14 posted by one or more users 12 of a social network. Respective users 12 may post messages 14 about topics of interest to the user 12, including textual descriptions, and occasionally including a reference 16 to a content item 16, such as the URL of a web resource that may be of interest to other users 12. Some of the content items 18 may be statically popular; e.g., a biography of a popular actress may often be referenced by users 12 at a large, but steady and predictable, frequency. However, the users 12 may also begin posting references 16 to particular content items 18 at a significantly higher or lower frequency than previously referenced. Such trends in the referencing of content items 18 may provide useful information. For example, in the exemplary scenario 10 of FIG. 1, if users receive information that a popular actor has suddenly passed away, the users 16 may suddenly begin posting messages 14 containing references 16 to an actor biography 18 (e.g., a web page on a movie database website or in a people encyclopedia website) at a much higher rate than previously detected. As a second example, a user 16 visiting a website featuring a weather radar may notice an interesting weather pattern developing, such as a tornado, and may post a message 14 including a reference 16 to the weather radar website. Other users 12 may view this message 14 and may post similar messages 14 to notify other users 12, and the rapid surge in references 16 to the content item 18 comprising the weather radar website may be detected. In contrast with identifying the static popularity of such content items 18, detecting these trends in the frequency of references 16 to such content items 18 may identify some new and useful information known or perceived by users 12 even before it is formally acknowledged, e.g., reported as a breaking news story by conventional news sources.

However, it may be difficult to configure a computer system to identify trends in the references 16 to such content items 18. In particular, the sheer volume of messages 14 to be evaluated in order to identify trends may be very large, such as millions of email messages, instant messages, or posts in a social network. Moreover, the trend information may be valuable only if detected quickly, so techniques that improve the efficiency of the evaluation of messages 14 to detect trends in the frequency of references 16 may be advantageous, while techniques that may delay such detection may impair the value of the yielded information. In particular, in implementations involving many computer systems (such as a server farm), some techniques may provide predictable and significant advantages in the rapid and sensitive detection of trends through scalability, e.g., by allowing an administrator to achieve speed and sensitivity gains proportional to a number of new servers added to the server farm, while other techniques may provide limited or no advantages, or may even reduce the detection of trends.

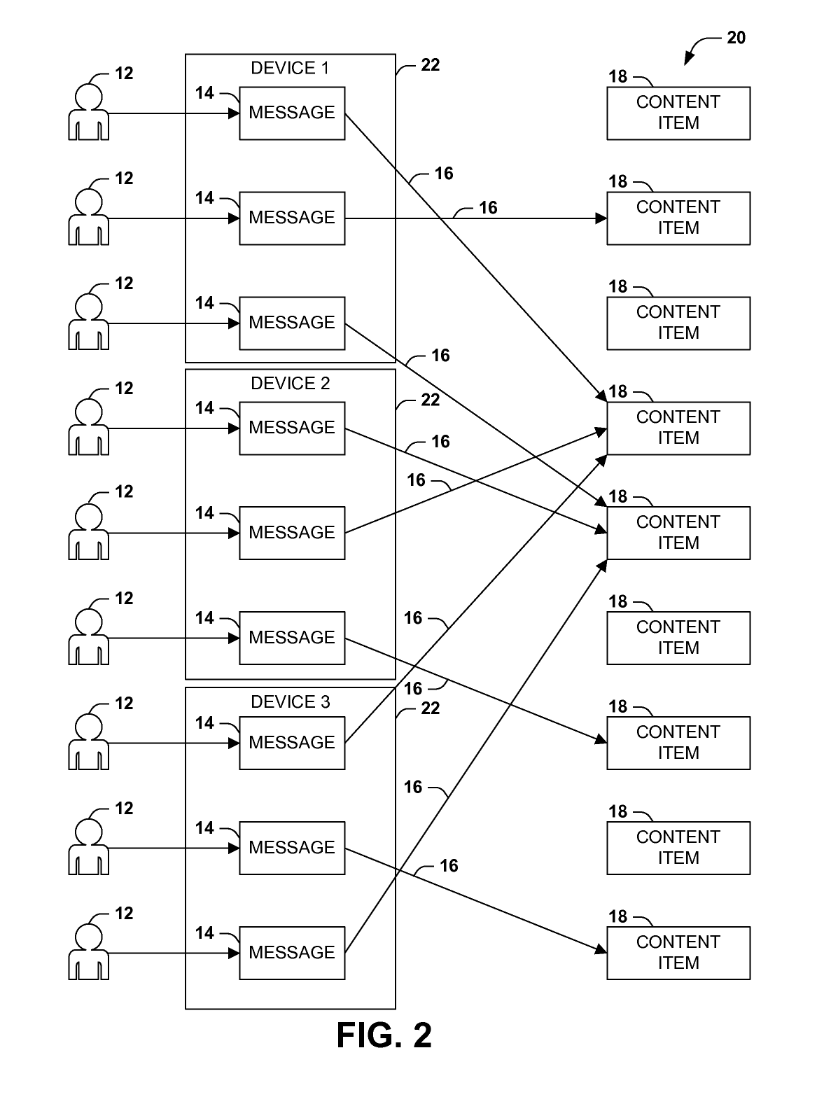

FIG. 2 presents an exemplary scenario 20 featuring a first configuration of devices is configured to detect trending content items 18 by identifying trends in the frequency of references 16 posted in messages 14 of users 12 of a social network to such content items 18. The configuration involves a set of devices 22, each of which is configured to monitor a portion of the messages 14 (e.g., either as an arbitrary portion of the entire set of messages 14, or the messages 14 posted by an arbitrary subset of users 12 in the entire set of users 12 of the social network.) A device 22 detects a trend in the frequency of references 16 to a particular content item 18 (e.g., by comparing a detected frequency of references 16 to a particular content item 18 to a predicted or typical frequency of references 16 to the content item 18), and may report a detected trend to another server, such as a central database. In this manner, the configuration of devices 22 may promote the evaluation of all of the messages 14 posted in the social network in a rapid manner in order to detect some trending content items 18. Moreover, this configuration may be scalable to improve rapidity and/or to handle a larger volume of messages 14; e.g., additional devices 22 may be included and configured to handle additional messages 14 and to process a set of messages 14 faster. However, this configuration may also limit the sensitivity of detection of trending content items 18. For example, in the exemplary scenario 20 of FIG. 2, all content items 18 may typically be referenced once by the depicted set of users 12, but two particular content items 18 are referenced in three references 16 included in messages 14 posted by various users 12. This frequency may indicate a trend of significantly greater frequency of references 16 to these content items 18. However, the devices 22 may not detect this trend, because the references 16 may be included in messages 14 that are evenly distributed among the devices 22, such that each device 22 only detects one reference 16 to each content item 18, which is consistent with the expected frequency of references 16 thereto. Accordingly, this configuration of devices 16 may not be suitably scalable to detect trending content items 18 with an acceptable level of sensitivity. Other techniques may present improved sensitivity, but at an expense of speed, capacity, and/or scalability.

Presented herein are techniques for detecting trending content items 18 by evaluating the frequency of references thereto 16, such as may be included in messages 14 of users 12 of a social network, in requests of users to play particular media items in a media library, in accesses of various types of data objects in a computer system by various software processes, etc. These techniques involve, for particular messages 14, generating a set of content item histograms, each of which comprises a set of reference counts of references 16 to a particular content item 18 that are detected within a reference period of a particular duration, such as a minute, an hour, or a day. The content item histogram may be implemented, e.g., as an integer array, where the first element of the integer array comprises a numeric count of references within a current reference period, while subsequent elements comprise the numeric count of references within a previously elapsed reference period. The content item histogram may also include a last reference time, indicating the date and/or time of the last detected reference 16 to the content item 18.

According to these techniques, when a reference 18 to a new content item 18 is detected, an embodiment of these techniques may generate a new content item histogram for the content item 18, comprising, e.g., a single reference count (representing the current reference count of the current reference period) with an initial value of zero. The embodiment may then record the reference 16 to the content item 18 by incrementing the current reference count. Additionally, the embodiment may set the last reference time for the content item histogram to the current date and/or time. Also, upon detecting the reference 16, the embodiment computes and stores a trend score for the content item 18 indicating, based on the content item histogram, the trendiness of the content item 18 at the time of the last detected reference 16. For example, a positive trend score may indicate a recent positive trend in the content item 18 (such as a significant rise in the frequency of references 16 thereto); a negative trend score may indicate a recent negative trend in the frequency of references 16; and a zero trend score may indicate no change in the frequency of references 16 as compared with previous measurements.

Further according to these techniques, at a second (subsequent) time, such as upon the request of a user 12 or an elapsed period, the embodiment may compare the trend scores of the content items 18 to identify trending content items 18. The embodiment may do so by comparing the trend scores set for each content item 18, but an inaccurate comparison may result if, e.g., a content item 18 that was previously referenced with high frequency has not been referenced in a significant period of time. For example, users 12 who are closely monitoring an emerging storm condition on a weather radar (and who are generating many references 16 indicating a strongly trending content item 18) may promptly lose interest if the storm condition suddenly dissipates. However, the content item histogram may only show a high reference count as the last recorded current metric, and an embodiment may continue to identify this website as a trending content item 18, even after users 12 stop generating references 16 to the website. Therefore, in comparing the trend scores of respective content items 18, an embodiment may “decay” each trend score, according to the difference of the last reference time and the second time at which the reporting of trending content items 18 is generated. For example, the trend scores for content items 18 that continue to be frequently referenced may remain the same, but the trend scores for content items 18 that have not been referenced in some time may be decayed to a significantly lower value, proportional with the duration of lapses in references 18 (e.g., a reference lapse interval.) The embodiment may then compare the “decayed” trend scores to identify trending content items 18. In this manner, the embodiment may improve the accurate detection and reporting of trending content items 18, while also achieving efficient evaluation of the references 16 and storing of detected reference counts in the content item histograms of each content item 18. Moreover, this configuration may promote the scalability of the system to evaluate more references 16, and/or to evaluate a batch of references 16 more quickly to improve the rapid detection of trending content items 18.

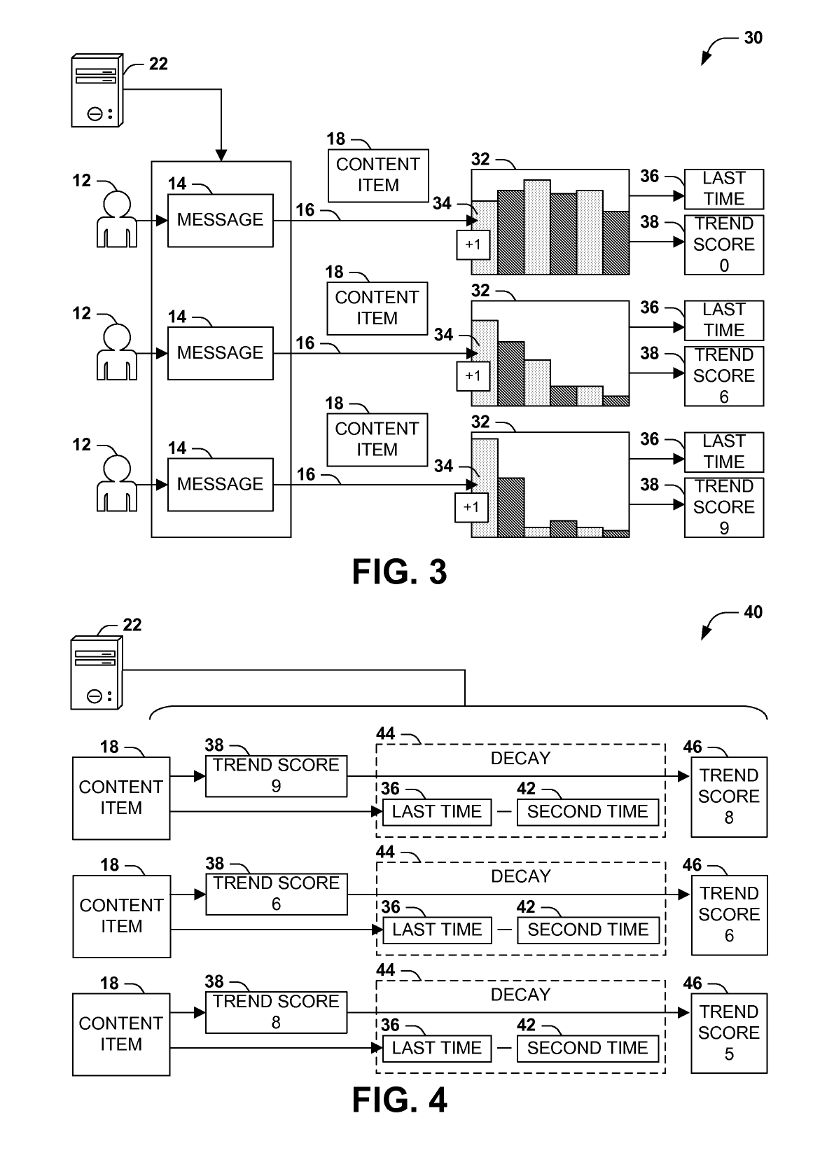

FIGS. 3-4 together illustrate these techniques, as may be performed by a device 22 configured to detect trending content items 18. In the exemplary scenario 30 of FIG. 3, the device 22 monitors a set of messages 14 generated by a set of users 12, which may contain references 16 to a particular content item 18. The device 22 may also generate and maintain, for respective content items 18, a content item histogram 32 indicating one or more reference counts detected within one or more reference count periods, including a current reference count 34 representing the number of references 16 detected in a current reference count period. Upon detecting such a reference 16, the device 22 may first determine whether this is the first reference 16 to the content item 18 that has been detected; if so, the device 22 may generate the content item histogram 32 for the content item 18. The device 22 may then increment the current reference count 34 for the current reference count period to record the detected reference 16. The device 22 also sets a last reference time 36 for the content item 18 as the current date and/or time to indicate the date or time of the latest detected reference 16 thereto. The device also evaluates the content item histogram 32 and sets a trend score 38 for the content item 18 indicating, as of the last reference time 36, the trendiness of the content item 18. For example, a first content item 18 may be associated with consistently high frequencies of references 16, but the consistency of the frequency (especially of the recent reference counts as compared with previous reference counts) may indicate a lack of trendiness, resulting in a trend score 38 of zero. The content item histogram 32 for a second content item 18 may indicate a steady upward trend in the frequency of references 16, resulting in a trend score 38 of six, and a content item histogram 32 for a third content item 18 may indicate a sharp upward trend (such as a recent surge) in the frequency of references 16, resulting in a trend score 38 of nine.

In the exemplary scenario 40 of FIG. 4, at a second time 42 (subsequent to that illustrated in FIG. 3), the device 22 may use the computed trend scores 38 of the content items 18 to identify trending content items 18. In particular, the device 22 may, for respective content items 18, execute a decaying 44 of the trend score 38 based on the difference between the second time 42 and the last reference time 36 of the content item 18, in order to account for content items 18 to which a reference 16 has not been detected in a significant period. For example, for a first content item 38, a brief period without a detected reference 16 may have elapsed, so the trend score 38 of nine may be decayed 44 to an adjusted trend score 46 of eight. A second content item 38 may not have exhibited any significant delay in the detection of references 16 (e.g., last reference time 36 may approximately equal the second time 42), so the trend score 38 of six may be decayed 44 by a factor of zero to produce an adjusted trend score 46 of six. By contrast, a third content item 18 may have started with a trend score 38 of eight, but a significant period may have elapsed since the last detected reference 16, and the decaying 44 may produce a significantly decayed adjusted trend score 46 of five. In this manner, the device 22 may adjust the order of trending content items 18 from a first order to a second order (based on the decaying 44) that may improve the accuracy of the trending detection.

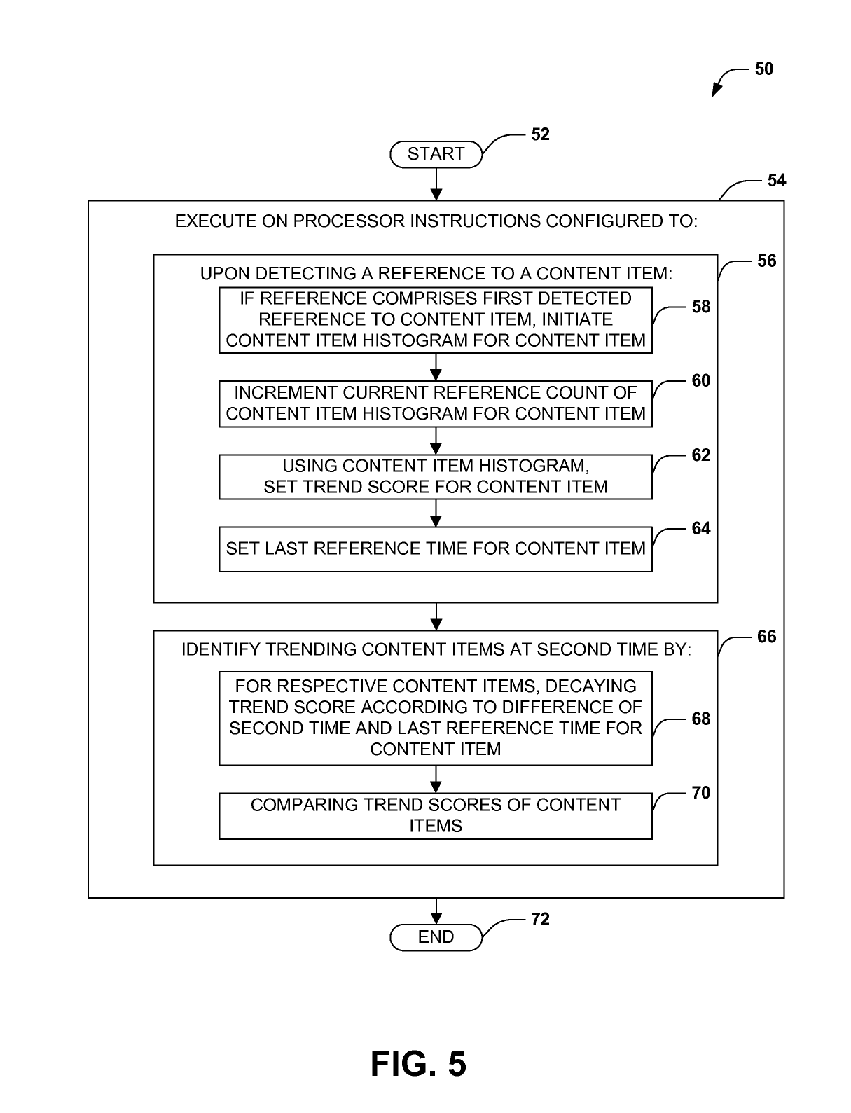

FIG. 5 presents a first embodiment of these techniques, illustrated as an exemplary method 50 of identifying trending content items 18 based on references 16 to the content items 18. The exemplary method 50 may be implemented on a device 22 having a processor, e.g., as a set of software instructions stored in a volatile memory, such as system RAM, or nonvolatile memory, such as a hard disk drive, a solid state drive, a flash storage device, or an optical disc. The exemplary method 50 begins at 52 and involves executing 54 on the processor instructions configured to implement the techniques presented herein. In particular, the instructions are configured to, upon detecting 56 a reference 16 to a content item 18, first determine if the reference 16 comprises a first detected reference 16 to the content item 18, and if so, to initiate 58 a content item histogram 32 for the content item 18. The instructions are also configured to, upon detecting 56 the reference 16, increment 60 a current reference count 34 of the content item histogram 32 for the content item 18; to, using the content item histogram 32, set 62 a trend score 38 for the content item 18; and to set 64 a last reference time 36 for the content item 18. The instructions are also configured to, at a second time 42, identify 66 trending content items 18 by, for respective content items 18, decaying 68 the trend score 38 according to a difference of the second time 42 and the last reference time 36 for the content item 18, and comparing 70 the trend scores 38 of the content items 18. In this manner, the instructions may be configured to cause the device 22 to perform the techniques presented herein, and so ends at 72.

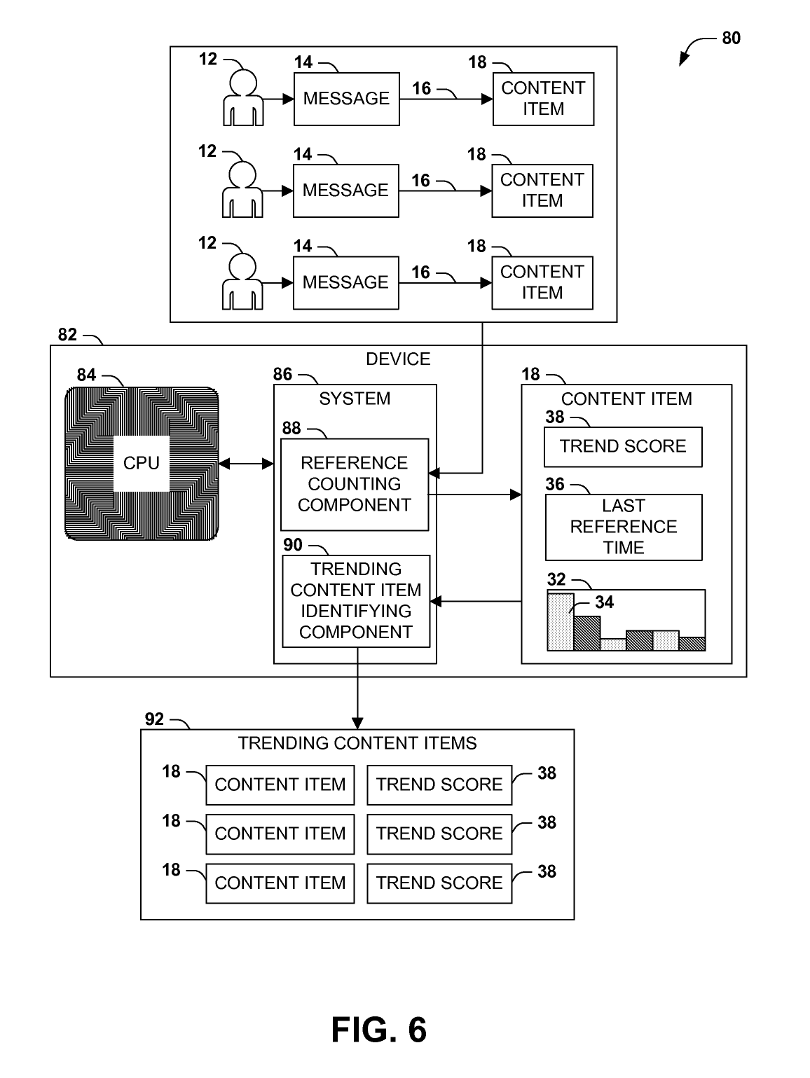

FIG. 6 presents an illustration of a second scenario featuring a second embodiment of the techniques presented herein, comprising an exemplary system 86 configured to identify trending content items 18 based on references 16 to the content items 18. The exemplary system 86 may be implemented, e.g., as a software architecture comprising instructions stored in a memory of the device 82 and configured to implement components that together implement these techniques, and/or as one or more hardware components that implement various aspects of these techniques. The exemplary system 86 operates on a device 82 having a processor 84, and having access to at least one content item 18. The exemplary system 86 comprises a reference counting component 88, which is configured to, upon detecting a reference 16 to a content item 18, determine whether the reference 16 comprises a first detected reference 16 to the content item 18, and if so, to initiate a content item histogram 32 for the content item 18. The reference counting component 88 is also configured to increment a current reference count 34 of the content item histogram 32 for the content item 16; using the content item histogram 32, to set a trend score 38 for the content item 18; and to set a last reference time 36 for the content item 18. The exemplary system 86 also comprises a trending content item identifying component 90, which is configured to, at a second time 42, identify trending content items 18 by, for respective content items 18, decaying 44 the trend score 38 according to a difference of the second time 42 and the last reference time 36 for the content item 18, and then comparing the trend scores 38 of the content items 18. In this manner, the exemplary system 86 causes the device 82 to identify trending content items 18 among the set of content items 18 according to the techniques presented herein.

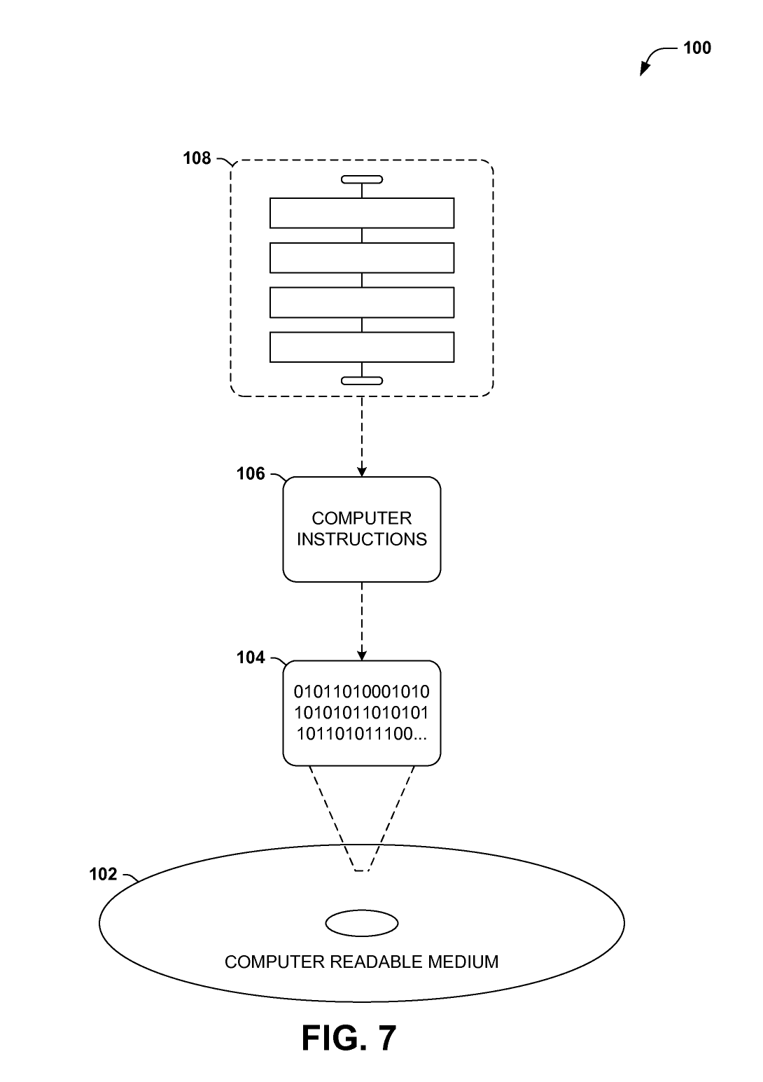

Still another embodiment involves a computer-readable medium comprising processor-executable instructions configured to apply the techniques presented herein. An exemplary computer-readable medium that may be devised in these ways is illustrated in FIG. 7, wherein the implementation 100 comprises a computer-readable medium 102 (e.g., a CD-R, DVD-R, or a platter of a hard disk drive), on which is encoded computer-readable data 104. This computer-readable data 104 in turn comprises a set of computer instructions 106 configured to operate according to the principles set forth herein. In one such embodiment, the processor-executable instructions 106 may be configured to perform a method of identifying trending content items among a set of content items, such as the exemplary method 60 of FIG. 5. In another such embodiment, the processor-executable instructions 106 may be configured to implement a system for identifying trending content items among a set of content items, such as the exemplary system 86 of FIG. 6. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques presented herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 60 of FIG. 5 and the exemplary system 86 of FIG. 6) to confer individual and/or synergistic advantages upon such embodiments.

A first aspect that may vary among embodiments of these techniques relates to the scenarios wherein such techniques may be utilized. As a first example, users 12 of a social network may post messages 14 (e.g., publicly accessible posts that may be viewed by all other users of the social network, and/or private messages directed to particular users of the social network) that include references 16 to various content items 18, such as uniform resource locators (URLs) identifying web resources, such as web pages containing a particular story or content item. As a second example of this first aspect, in a media library, one or more users 12 may request to have rendered various media items (such as playing music or showing videos), and the renderings (as a type of reference 16) of such media items may be tracked in order to interpret trends in popularity among the media-based content items 18. As a third example of this first aspect, a commercial enterprise may identify trends in the interest or purchase by patrons of various goods or services (wherein the representations of the products comprise content items 18, and the purchases, recommendations, reviews, or viewings thereof may comprise references 16 thereto.) As a fourth example of this first aspect, various software processes in a computer system may utilize various data objects in a data object set, such as functions in an advanced programming interface (API), files in a filesystem, records in a database, or data entries in a data cache, and the computer system may be capable of exhibiting improved performance by providing quicker access to data objects of trending use. The trending usage of such data objects (as content items 18) may be tracked by monitoring the usage of utilizations (comprising references 16) to such data objects.

As a fifth example of this first aspect, users or devices may request or provide information about various locations (e.g., reports of locations detected by global positioning system (GPS) receivers), and the accessing and/or reporting of information about such locations (comprising references 16 to content items 18) may be evaluated. Trends in the references 16 to such locations may be detected in order to identify areas that are popular, crowded (e.g., locations that are congested with automobile traffic), and/or interesting (e.g., locations often depicted in geotagged photographs.) However, some additional processing may be involved to associate references 16 with particular locations (as content items 18), due to the precision of the references 16 detected by GPS receivers. For example, a particular location may correspond to an area of variable size and shape; e.g., the location corresponding to a small monument (such as a small statue) may comprise a small, circular geographic area near the monument, but the location corresponding to a large landmark (such as the Parthenon) may comprise a very large area of unusual shape. However, a GPS receiver may simply report the location of the user 12 as a point, such as a detected latitude and longitude coordinate. Therefore, an embodiment may have to translate the reference 16 into a more generalized reference in order to identify the content item 18 (e.g., the location) that is referenced by the reference 16.

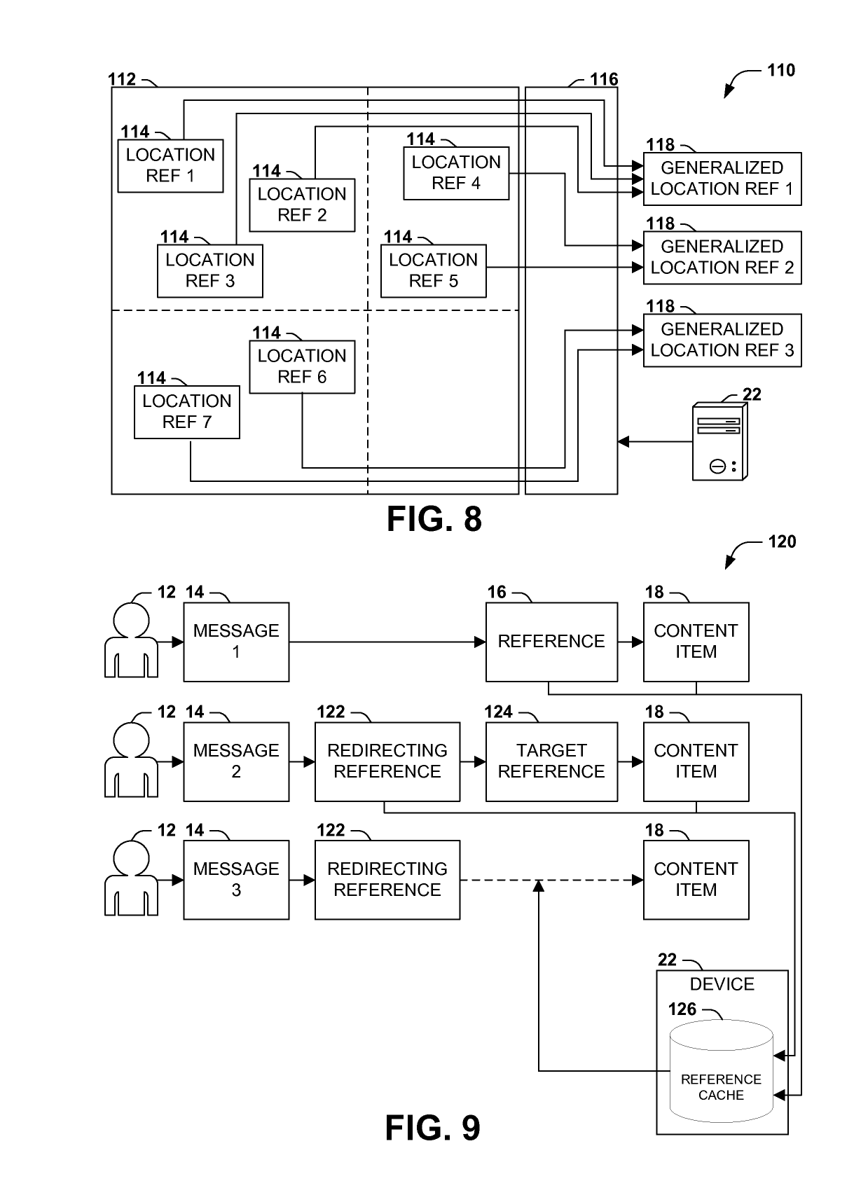

FIG. 8 presents an exemplary scenario 110 illustrating this fifth example of this first aspect. In this exemplary scenario 110, within a geographic area 112, various location references 114 may be reported (e.g., detected by global positioning system (GPS) devices operated by various users 12), and may comprise a set of latitude and longitude coordinates having a particular precision. However, it may not be helpful to represent every coordinate reported by a GPS device as a distinct location, particularly if a location of interest (such as the area comprising a landmark) encompasses several or many coordinates. Accordingly, a device 22 that is configured to track trends in the location references 114 may be configured to, for a particular location reference 114, compute 116 a generalized location reference 118, such as a range of location references 114 that together refer to the same location, such as a landmark. For example, in the exemplary scenario 110 of FIG. 8, the geographic area 112 may be divided into quadrants, such as ranges of geographic coordinates that map to a single represented location. When a location reference 114 is detected, the device 22 may compute 116 a generalized location reference 118 by translating the location reference 114 into a particular quadrant 116 encompassing the coordinate. The device 22 may then use the generalized location reference 118 as a reference 16 to a content item 18 (e.g., the referenced location) in order to identify trends among the generalized location references 118 to identify trends among such references 16. Those of ordinary skill in the art may identify many scenarios wherein the techniques presented herein may be utilized.

A second aspect that may vary among embodiments of these techniques relates to the manner of identifying references 16 to a particular content item 18. As a first example, a reference 16 may directly identify a content item 18, such as an identifier (e.g., a name, a key value in a database, or a uniform resource locator (URL)) that distinctively and directly identifies a particular content item 18 among the set of content items 18. However, in other scenarios, processing may have to be performed to identify the reference 16 and/or the content item 18 referenced thereto. As a second example of this second aspect, the reference 16 may be included in a message 14, such as a private message sent by a first user 12 to a second user 12 or a post published by a user 12 on a social network; however, the message 14 may primarily comprise another form of data, such as text, a database, or an image, that embeds one or more references 16 in a particular format. In a first such scenario, the message may include a telephone number, an address, a uniform resource locator (URL), or a geographic coordinate, and the device 22 may extract the reference 16 through textual parsing of the message 14 (e.g., by applying a regular expression to the message 14 that identifies telephone numbers or email addresses based on the established format thereof.) In a second such scenario, users 12 of a social network may utilize a “hashtag” format to identify, within a textual contents of a message 14, the names of one or more topics associated with the message 14. An exemplary “hashtag” format may comprise, e.g., a reference to the sport of tennis in the phrases: “I played #tennis today!” and “I watched Wimbledon on television. #tennis”. The device 22 may therefore evaluate messages 14 to identify hashtag-labeled references 16 embedded in such messages 14 in order to identify trends among the references 16 to various content items 18.

As a third example of this second aspect, a first reference 16 may not directly identify a particular content item 18, but may instead identify a second reference 16 that (directly or indirectly) identifies a content item 18. In view of various considerations, a user 12 may generate the first reference 16 in order to encourage other users 12 (or the devices operated thereby) to be redirected to the content item 18 identified by the second reference 16. For example, some social networks may limit the size of posted messages 14 to a particular textual length, which may be insufficient to include an entire reference 16 (such as a uniform resource locator (URL) identifying a particular content item 18 but having an unusually large length.) Therefore, the first user 12 may use another service, such as a URL shortening service, to generate a shorter URL that translates to the longer URL that translates to the content item 18. The first user 12 may then post the shorter URL in a message 14, and the second user 12, upon accessing the shorter URL, may be redirected to the target URL that identifies the content item 18. As a second example, news story may be referenced and linked to by a first weblog article (serving as a direct reference) generated by a first weblog author. A second weblog author may generate a second weblog article linking to the first weblog article, but the topic of the second weblog article may be the original news article, not the first weblog article that the second weblog article directly references.

In these and other examples, a “redirecting” reference may not directly identify a content item 18, but may identify a “target” reference that directly references the content item 18. Alternatively, the “target” reference may indirectly reference the content item 18 by, in turn, redirecting the user 12 to a third reference 16 that identifies the content item 18. While this technique may be advantageous or desirable for users 12, it may complicate the detection of references 16 to a particular content item 18. Accordingly, when a device 22 tracking the trends in content items 18 detects a reference, the device 22 may examine the reference 16 to determine whether or not the reference 16 references a target reference. If so, the reference 16 may examine the target reference in order to identify whether it also references a third reference (as a second target reference.) Eventually, the device 22 may identify a non-redirecting reference 16 that identifies a content item 18, and may use this reference 16 in the tracking of trends of references 16 to content items 18.

Moreover, the device 22 may utilize a reference cache, which may store (as key/value pairs) references 16 previously encountered and the content items 18 that are directly or indirectly referenced thereby. For example, when the device 22 detects a reference 16 and identifies the content item 18 that is directly or indirectly referenced thereby, the device 22 may store the reference 16 and the identified content item 18 in the reference cache. Upon encountering another reference 16, the device 22 may search the reference cache to determine whether the reference 16 has been previously encountered and associated with a particular content item 18. If so, the device 22 may, instead of examining the reference 16 to determine the referenced content item 18, utilize the association stored in the reference cache. This caching of associations of references 16 to content items 18 may be advantageous, e.g., for promoting the performance (since examining the reference cache may be faster than dereferencing the reference 16 to identify the referenced content item 18), and/or may promote the robustness of the trend tracking (e.g., a redirecting reference 16 refers to a target reference 16 that is no longer available, but the reference cache may identify the content item 18 that was previously referenced by the target reference 16.)

FIG. 9 presents an illustration of an exemplary scenario 120 featuring the identification of trending content items 18 that are referenced both directly by some references 16 and by redirecting references 16 that indirectly reference the content item 18. In this exemplary scenario 120, a first message 14 posted by a user 12 may include a reference 16 that directly identifies a content item 18, and may record the reference 16 in a content item histogram 32 according to the techniques presented herein. A user 12 may post a second message 14 including a redirecting reference 122 to a target reference 124 (e.g., a shortened URL that, when accessed, redirects to a full-length URL that distinctively identifies the content item 18.) Instead of incorrectly identifying the target reference 124 as the content item 18 referenced by the redirecting reference 122, the device 22 may identify the redirection, may follow the target reference 124, and may identify both the redirecting reference 122 and the target reference 124 that both identify the content item 18. Moreover, the device 22 may store these associations in a reference cache 126, such that if a third message 14 is subsequently detected that also includes the redirecting reference 122, the device 22 may, upon determining that the reference cache 126 includes the redirecting reference 122, and may utilize the association stored in the reference cache 126 to determine that the redirecting reference 122 identifies the content item 18, rather than having to dereference the redirecting reference 122 and the target reference 124 to identify the referenced content item 18. In this manner, the device 22 may track the referencing of content items 18 with improved accuracy and/or performance. Those of ordinary skill in the art may devise many techniques for identifying content items 18 referenced by various references 16 while implementing the techniques presented herein.

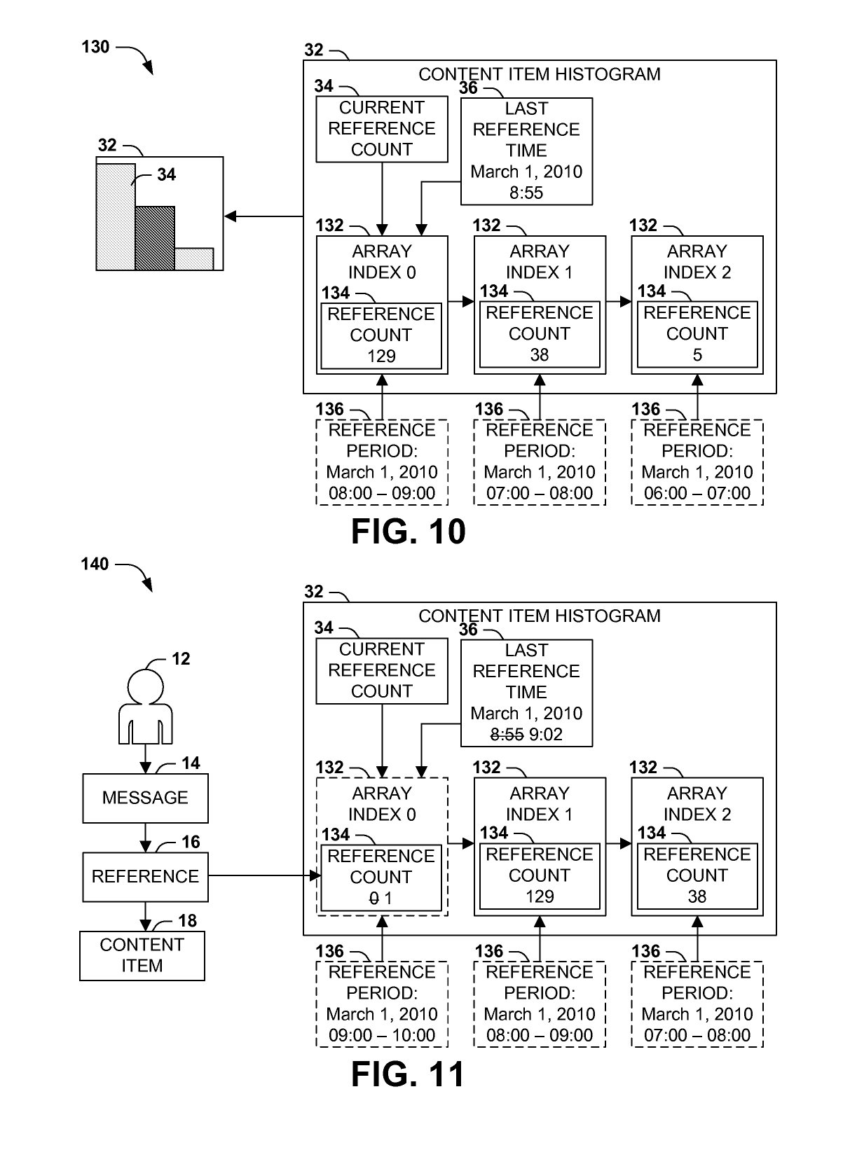

A third aspect that may vary among embodiments of these techniques relates to the nature of content item histograms 32 used herein to count detected references 16 to a content item 18. Many data structures or data objects may be used to store this information, and some variations may present advantages over other variations. As a first example of this third aspect, FIGS. 10-11 together illustrate an exemplary implementation a content item histogram 32 that may be used in the techniques presented herein, such as by using the content item histogram 32 to store (and count) the detected references 16 to the content item 18. In these exemplary scenarios, the content item histogram 32 comprises a set of integers, such as an array or a linked list of memory structures, each storing an integer representing a reference count 134 for a particular reference period 136, and a memory reference to the next memory structure (e.g., with the final memory structure in the array having a memory reference of NULL to indicate the termination of the array.) Each memory structure is identified by an array index according to its ordinal position in the array, with the first memory structure having array index zero, the second memory structure having array index one, etc. Moreover, the array is organized such that the first memory structure stores the current reference count 34 for the current reference period 136, while each following memory structure represents an adjacently earlier reference period 136. In this manner, the reference counts 134 for successively earlier reference periods 136 are stored later in the list in reverse chronological order, thus resembling the graphical representation of the content item histogram 32.

In the exemplary scenario 130 of FIG. 10, the content item histogram 32 is implemented as an array, wherein respective array indices 132 reference memory structures that store integers representing reference counts 134 for respective reference periods 136. In this implementation, the boundaries of the particular reference periods 136 are not stored. Rather, the first array index 132 stores the current reference count 34 for the current reference period 136, and each successive array index 132 stores the reference count 134 for an adjacently preceding reference period 136. The duration of the respective reference periods 136 may be fixedly defined in the software implementation of the content item histogram 32, in a configuration file associated with the software implementation, by user selection, etc. Moreover, the current reference period 136 is indicated by the last reference time 36, which is stored (and updated) upon detecting each reference 16 to the content item 18 represented by the content item histogram 32. As a first example, the last reference time 36 may indicate the date and/or time at which a reference 16 to the content item 18 was last detected. As a second example, the last reference time 36 may indicate the latest date and/or time associated with any detected reference to the content item 18 (e.g., particular references 16 may include a time-stamp indicating a time of generation, such as a date of a message 14 posted by a user 12, and the latest time-stamp may be used to determine the last reference time 36, regardless of when the reference 16 was detected.) As a third example, the last reference time 36 may indicate the date and/or time indicating the beginning or end of the current reference period 136. When a device 22 detects a reference 16 to the content item 18 represented by the content item histogram 32, the reference count 134 of the first array index 132, corresponding to the current reference count 34, may be incremented to record the detected reference 16. The current reference count 34 may then be compared with the reference counts 134 of the other array indices 132 to identify a trend in the references 16 to the content item 18.

When a reference 16 to the content item 18 represented by the content item histogram 32 is detected (e.g., in a message 14 posted by a user 12), an embodiment of these techniques may increment the current reference count 34 of the array index representing the current reference period 136. However, the embodiment also examines the last reference time 36 to determine whether the first array index 132 still represents the current reference period 136. As a first example, if each reference period 136 is of a specified duration, such as one hour, and if the last reference time 36 indicates that the previous reference 16 was detected within a particular hour (e.g., within an eight o'clock hour of a particular morning), the current time may be compared to determine whether the latest reference 16 was detected within the same hour. As a second example, if the last reference time 36 indicates the date and/or time comprising the beginning and/or end of the reference period 136 at which the previous reference 16 was detected, the current time may be examined to determine whether the current reference 16 was detected within the same reference period 136. If so, the reference count 134 of the first array index 132 (corresponding to the current reference count 34) may be incremented, and the last reference time 36 may be updated with the current time. However, if the reference period 136 during which the previous reference 16 was detected has since ended, one or more new array indices 132 may be inserted at the beginning of the array, with an initial reference count 134 of zero, to indicate the intercession of one or more reference periods 136 since the previously detected reference 16. Multiple array indices 132 may be inserted if intervening reference periods 136 have passed without the detection of even one reference 16 to the content item 18.

FIG. 11 presents an exemplary scenario 140 that further illustrates the use of the content item histogram 32. In this exemplary scenario, each array index 132 represents a reference period 136 of a one-hour reference period duration, lapsing at the top of each hour. However, when an embodiment of these techniques first examples the last reference time 36, it is determined that the latest reference 16 is detected within the nine o'clock hour of a morning, while the previous reference 16 was detected within the eight o'clock hour of the same morning. Accordingly, instead of incrementing the reference count 134 representing the reference period 136 of the eight o'clock hour, the array is adjusted by inserting one array index 132 at the front of the array, with an initial reference count 134 of zero. This new array index 132 represents the current reference count 34 for the current reference period 136 comprising the nine o'clock hour of the morning. The reference count 134 of this first array index 132 may then be incremented to record the detected reference 16 to the content item 18, and the last reference time 36 may be updated to indicate the date and time of the last detected reference 16. In this manner, the array is utilized to record the detection of references 16 as a content item histogram 32, and is updated to indicate the passage of time.

While FIGS. 10-11 together illustrate one exemplary implementation of the content item histogram 32, many other implementations may also be selected. As a first example, the array may be organized in forward chronological order, with the current reference period 136 stored as the last array index 132 and preceding array indices 132 representing adjacently preceding reference periods 136. As a second example, if only a particular number of reference periods 136 preceding the current reference count 34 are deemed relevant to trend detection, a maximum array size may be specified, and when one or more array indices 132 are inserted, the oldest array indices 132 may be removed if the array exceeds the maximum array size. As a third example, the array may be represented in a data structure other than a linked list, e.g., as a simple ASCII or Unicode text string, comprising a sequence of integers separated by whitespace and indicating the reference counts 134 for respective reference periods 136.

A fourth aspect that may vary among embodiments of these techniques relates to the setting of a trend score 38 for respective content items 18 based on the content item histograms 32 associated therewith. As a first example, the trend score 38 may be computed as a change magnitude of recent reference counts 134 to the content item 18 in the content item histogram 32, as compared with earlier reference counts 134 to the content item 18 in the content item histogram 32. As a second example, the trend score 38 may be computed as a slope of a curve over the reference counts 134, possibly with changes between later reference counts 134 weighted more heavily than changes between earlier reference counts 134. Other computations of the trend score 18 may involve other statistical techniques and concepts, such as determinations of significant vs. insignificant changes.

As a third example of this fourth aspect, the content item histogram 32 may involve a set of at least two content item histograms 32, such as a set of two or more arrays, where each content item histogram 32 indicates the detection of references 16 over a different period. Each content item histogram 32 may accumulate reference counts 134 for particular reference periods 136 of different reference period durations, such as a minute, an hour, a day, and a week. It may be appreciated that trends in the referencing of a content item 18 (such as a news story or a geographic location) may arise in many ways, such as a rapid and sudden posting of references 16, or a steady growth of such references 16 over time. The use of multiple content item histograms 132 may permit the detection of several types of trends in the references 16 to the content item 18, such as a rapid detection of comparatively short-term trends (e.g., a sudden surge of users 12 generating references 16 to a particular content item 18 over the space of several minutes) and the detection of comparatively longer-term trends (e.g., a steady swelling of references 16 to a particular content item 18 over the span of a day or a week.) When a reference 16 is detected, the current reference count 34 of each content item histogram 32 representing the content item 18 may be incremented. Additionally, the trend score 38 for the content item 18 may be detected in view of all of these content item histograms 32, thereby providing a more sensitive and more accurate detection of trends of various types.

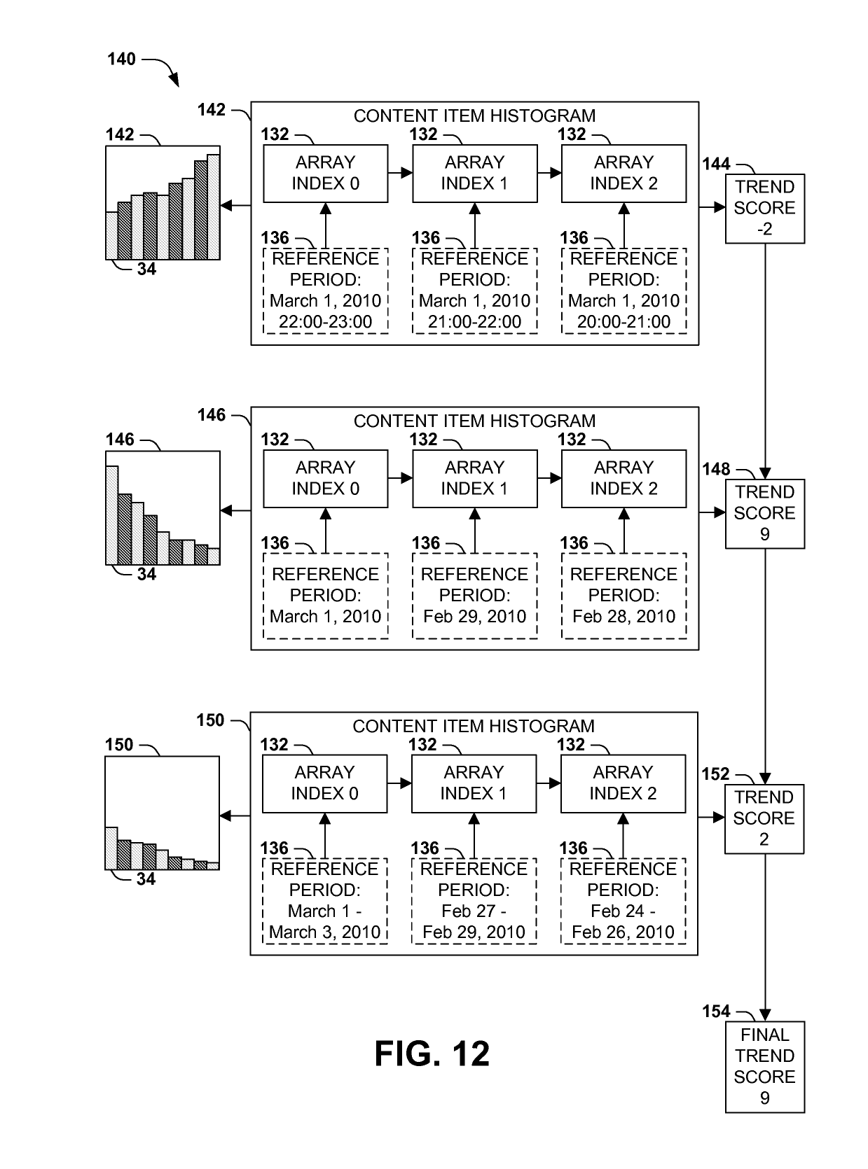

FIG. 12 presents an exemplary scenario 140 featuring three content item histograms 32, each implemented as a separate array and configured to store references 16 to the same content item 18, but over different periods. A first content item histogram 142 may feature array indices 132 representing reference periods 136 having a one-hour reference period duration; a second content item histogram 142 may feature array indices 132 representing reference periods 136 having a one-day reference period duration; and a third content item histogram 142 may feature array indices 132 representing reference periods 136 having a three-day reference period duration. In this exemplary scenario 140, the content item histograms 32 reveal different sets of information about the trending of the content item 18. The represented content item 18 may have begun exhibiting a steady positive trend over the past several days, as indicated by the second content item histogram 146. However, the first content item histogram 142 may actually reveal a shorter-term negative trend, because, on any particular day, the references 16 may be generated by users 12 more often during daytime hours (when the users 12 are more active) than during evening hours, so the reference counts 134 may decline as the day passes into evening. By contrast, the third content item histogram 150 may not yet reflect the positive trend in references 16 to the content item 18, as the results of the current reference period 136 are still being tabulated. Different results may be observed, e.g., for content items 18 that exhibit an explosively positive trend (which might be rapidly detected only by the first content item histogram 142, but not by the content item histograms 32 representing longer reference period durations), or that demonstrate a steady and positive but slower trend (which might only be detectable on the third content item histogram 150.)

By utilizing a plurality of content item histograms 32, an embodiment may detect multiple types of trends among the references 16 to the content item 18. For example, in the exemplary scenario 140 of FIG. 12, after incrementing the current reference counts 34 of the content item histograms 32, an embodiment may set a trend score 38 for each content item histogram 32, reflecting the trending of references 16 to the content item 18 within each content item histogram 32. The embodiment may then compute a trend score 36 for the content item 18 based on the multiple trend scores 36 of the respective content item histograms 32. In the exemplary scenario 140 of FIG. 12, a first trend score 144 is computed for the first content item histogram 142 (indicating the negative trend in detected references 16 to the content item 18); a second trend score 148 is computed for the second content item histogram 146 (indicating the strong positive trend in detected references 16 to the content item 18); and a third trend score 152 is computed for the third content item histogram 150 (indicating the slight positive trend in detected references 16 to the content item 18.) Among these trend scores 36, the maximum trend score 32 is selected as the final trend score 154 of the content item 18, based on the trending of references 16 thereto on a day-by-day basis, as reflected by the second content item histogram 146. However, other embodiments may utilize such trend scores 36 differently, e.g., by selecting a minimum trend score 36 or an average trend score 36. Those of ordinary skill in the art may devise many implementations and uses of the content item histograms 132 utilized in the techniques presented herein.

A fifth aspect that may vary among embodiments of these techniques relates to the decaying 44 of trend scores 32 while comparing content items 18 to identify trending content items 18. As described herein, a trend score 38 computed upon detecting a reference 16 a content item 18 may reflect reference counts 134 for reference periods preceding the detection of the latest reference 16, but may not reflect a period of inactivity between the last reference time 36 and a second (subsequent) time when the trend score 32 of the content item 18 is utilized, when no references 16 are detected during this period of inactivity. Because many content items 18 may exhibit at least a brief period of inactivity (and possibly a protracted period of inactivity) between the last reference time 36 of the content item 18 and the second time 42, the trend scores 38 may produce inaccurate results in trend detection unless adjusted to reflect the period of inactivity. Accordingly, and as a first example of this fifth aspect, upon comparing content items 18 at the second time 42, the trend scores 32 of respective content items 18 are decayed 44 based on the difference between the second time 42 and the last reference time 36 of the content item 18. For example, the trend scores 32 may be decayed 44 a fixed amount (such as one point) or by a fixed percentage (such as 10%) for each intervening reference period 136 between the last reference time 36 and the second time 42. Alternatively, progressive penalties may be applied to cause accelerating decaying 44 in view of more protracted periods of inactivity, such as a 2% decrease in the trend score 38 for a first reference period 136 with zero references 16, a 4% decrease in the trend score 38 for the second reference period 136, a 10% decrease in the trend score 38 for the third reference period 136, etc.

As a second example of this fifth aspect, the decaying 44 of trend scores 38 may be performed in order to produce a trending item content set having a trending content item set size, such as a “top ten trending items” content item set. Therefore, the content items 18 having the highest adjusted trend scores 46 (following the decaying 44 of the trend scores 38) may be selected for the content item set. Moreover, in scenarios where only the content items 18 of the trending content item set are of interest, the decaying 44 may be performed only for content items 18 that may be included in this trending content item set, such that computational resources are not expended by decaying 44 the trend scores 46 of content items 18 that cannot be included in the trending content item set. For example, the decaying 44 may be performed such that a first trend score 38 of a first content item 18 is decayed 44 before a second trend score 38 of a second content item 18 that is lower than the first trend score 38. Additionally, upon identifying adjusted trend scores 46 content items 18 that fill the trending content item set up to the trending content item set size, the decaying 44 may be ceased if no other content items 18 remain that have “undecayed” trend scores 38 (e.g., trend scores prior to decaying based on the elapsed time since the last reference) that are higher than the adjusted trend scores 46 of the content items 18 within the trending content item set. This technique may promote the conservation of computing resources while identifying the trending content items 18 (particularly if the set of content items 18 is large.)

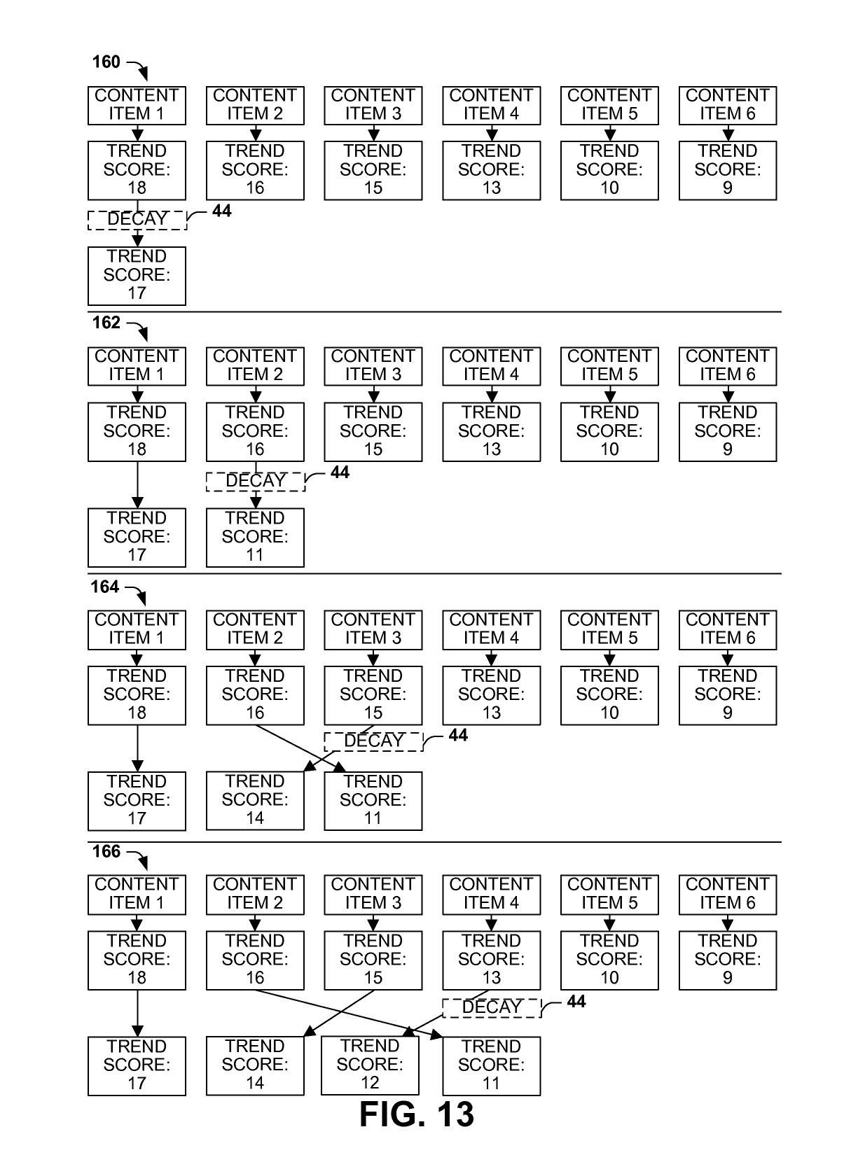

FIG. 13 presents an exemplary scenario illustrating this technique of decaying 44 the trend scores 38 of respective content items 18. In this exemplary scenario, in order to identify a set of three trending content items 18 having the highest adjusted trend scores 46, the content items 18 are first sorted according to the (undecayed) trend scores 38, and the content items 18 having higher undecayed trend scores 38 are decayed 44 before content items 18 having lower undecayed trend scores 38. At a particular second time (a second time 42), the content items 18 may be compared for trendiness in the following manner. At a first time point 160, a first content item 18 having a (highest undecayed) trend score 38 of eighteen is decayed 44 to produce an adjusted trend score 46 of seventeen (reflecting a brief period of inactivity since the last reference time 36.) Next, at a second time point 162, a second content item 18 having a (next highest undecayed) trend score 38 of sixteen is decayed 44 to produce an adjusted trend score of eleven (reflecting a comparatively long period of inactivity since the last reference time 36.) Next, at a third time point 164, a third content item 18 having a trend score 38 of fifteen is decayed to an adjusted trend score of fourteen, thereby reflecting a more positive trend in the third content item 18 than in the second content item 18. While three content items 18 having relatively high adjusted trend scores 46 have now been identified, it is possible that these are not the trendiest content items 18 in the content item set, because the fourth content item 18 presents an undecayed trend score 38 of thirteen, possibly exceeding the trendiness of the second content item 18. Therefore, at a fourth time point 166, trend score 38 of the fourth content item 18 is decayed 44 to an adjusted trend score 46 of twelve, thereby superseding the second content item 18 in the set of three trendiest content items 18. However, because the decaying 44 only reduces the trend score 38 of content items 18, no further decaying 44 is computed after this fourth time point 166, because no remaining content items 18 present an undecayed trend score 38 that is greater than the lowest adjusted trend score 46 in the set of three trendiest content items (i.e., the adjusted trend score 46 of twelve presented by the fourth content item 18.) Accordingly, the set of trendiest content items 18 may be regarded as having been deterministically selected, and computational resources may be economized by forgoing further decaying 44 of other content items 18. Those of ordinary skill in the art may devise many ways of decaying 44 the trend scores 38 of the content items 18 while implementing the techniques presented herein.

A sixth aspect that may vary among embodiments of these techniques involves various uses of the identified trending content items 18. As a first example, the trending may be utilized to adjust computational resources in order to improve efficiency and/or performance, e.g., by storing more frequently referenced content items 18 in a cache for quicker access. As a second example of this sixth aspect, where these techniques are implemented to identify trending products in a product set (such as by a commercial enterprise), the information relating to trending content items 18 may be used to adjust prices in response to demand (e.g., raising the prices of products demonstrating a positive trend, and/or reducing the prices of products demonstrating a negative trend) and/or inventory (e.g., ordering more units of products demonstrating a positive trend in anticipation of continued sales growth, and/or reducing orders of products demonstrating a negative trend.)

As a third example of this sixth aspect, the resulting information about trending content items may be displayed for a user 12, e.g., as a suggestion of content items 18 (such as news articles, websites, media objects, products, or geographic locations) that other users 12 are referencing in a trending manner. For example, a social network may use the information about trending content items 18 representing various web resources (identified by URLs included in messages 14 posted by various users 12) to present to a user 12 a list of trending web resources at a particular time, e.g., upon receiving a request from the user 12 to identify the trending content items 18. Such embodiments may present the trending content items 18 in various ways, e.g., sorted according to the trend scores 38 of the trending content items 18. Alternatively or additionally, an embodiment may proactively notify a user 12 of trending content items 18, e.g., by presenting a notification such as an instant message, a pop-up dialog, or an email message that indicates the trending content items 18.

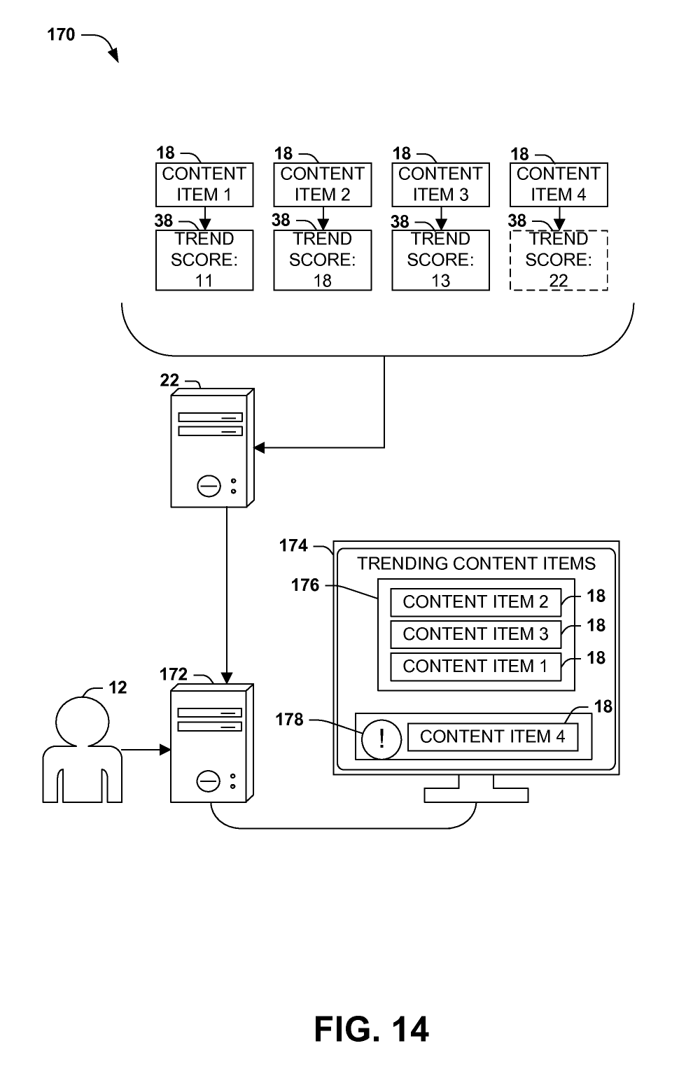

FIG. 14 presents an exemplary scenario 170 featuring a presentation 176 of trending content items 18 to a user 12. Upon identifying three trending content items 18 having comparatively high trend scores 38, a device 22 configured according to the techniques presented herein may communicate with a user device 172 operated by a user 12 that has a display 174, and may send data to the user device 172 (e.g., a web page) for rendering on the display 174 that presents the trending content items 18 (e.g., sorted according in order of descending trend scores 38, such that the content item 18 having the highest trend score 38 is presented first.) This presentation 176 may be rendered, e.g., upon the request of the user 12. Additionally, upon identifying a fourth content item 18 having a particularly high trend score 38 (e.g., a breaking news story), the device 22 may send information to the user device 172 to cause a notification 178 of the trending content item 18 to appear on the display 174 for presentation to the user 12. In this manner, the trending content items 18 identified according to these techniques may be presented to the user 12 either proactively or upon request. Those of ordinary skill in the art may devise many ways of using the information about trending content items 18 while implementing the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

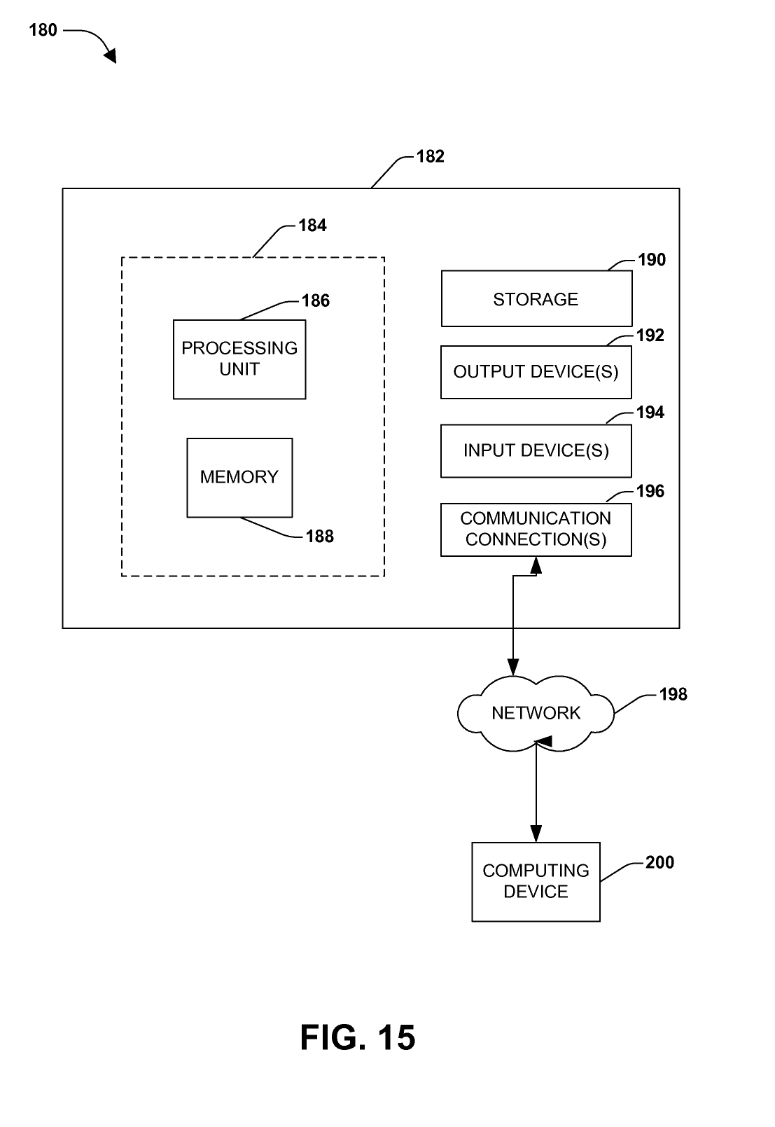

FIG. 15 and the following discussion provide a brief, general description of a suitable computing environment to implement embodiments of one or more of the provisions set forth herein. The operating environment of FIG. 15 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (presented herein.) Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 15 illustrates an example of a system 180 comprising a computing device 182 configured to implement one or more embodiments provided herein. In one configuration, computing device 182 includes at least one processing unit 186 and memory 188. Depending on the exact configuration and type of computing device, memory 188 may be volatile (such as RAM, for example), non-volatile (such as ROM, flash memory, etc., for example) or some combination of the two. This configuration is illustrated in FIG. 15 by dashed line 184.

In other embodiments, device 182 may include additional features and/or functionality. For example, device 182 may also include additional storage (e.g., removable and/or non-removable) including, but not limited to, magnetic storage, optical storage, and the like. Such additional storage is illustrated in FIG. 15 by storage 190. In one embodiment, computer readable instructions to implement one or more embodiments provided herein may be in storage 190. Storage 190 may also store other computer readable instructions to implement an operating system, an application program, and the like. Computer readable instructions may be loaded in memory 188 for execution by processing unit 186, for example.

The term “computer readable media” as used herein includes computer storage media. Computer storage media includes volatile and nonvolatile, removable and non-removable media implemented in any method or technology for storage of information such as computer readable instructions or other data. Memory 188 and storage 190 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 182. Any such computer storage media may be part of device 182.

Device 182 may also include communication connection(s) 196 that allows device 182 to communicate with other devices. Communication connection(s) 196 may include, but is not limited to, a modem, a Network Interface Card (NIC), an integrated network interface, a radio frequency transmitter/receiver, an infrared port, a USB connection, or other interfaces for connecting computing device 182 to other computing devices. Communication connection(s) 196 may include a wired connection or a wireless connection. Communication connection(s) 196 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 182 may include input device(s) 194 such as keyboard, mouse, pen, voice input device, touch input device, infrared cameras, video input devices, and/or any other input device. Output device(s) 192 such as one or more displays, speakers, printers, and/or any other output device may also be included in device 182. Input device(s) 194 and output device(s) 192 may be connected to device 182 via a wired connection, wireless connection, or any combination thereof. In one embodiment, an input device or an output device from another computing device may be used as input device(s) 194 or output device(s) 192 for computing device 182.

Components of computing device 182 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 182 may be interconnected by a network. For example, memory 188 may be comprised of multiple physical memory units located in different physical locations interconnected by a network.

Those skilled in the art will realize that storage devices utilized to store computer readable instructions may be distributed across a network. For example, a computing device 200 accessible via network 198 may store computer readable instructions to implement one or more embodiments provided herein. Computing device 182 may access computing device 200 and download a part or all of the computer readable instructions for execution. Alternatively, computing device 182 may download pieces of the computer readable instructions, as needed, or some instructions may be executed at computing device 182 and some at computing device 200.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of identifying trending content items based on references to the content items on a device having a processor, the method comprising:
executing on the processor instructions configured to:
upon detecting a reference to a content item:
if the reference comprises a first detected reference to the content item, initiate a content item histogram for the content item;
increment a current reference count of the content item histogram for the content item;
using the content item histogram, set a trend score for the content item; and
set a last reference time for the content item; and
identify trending content items at a second time by:
for respective content items, decaying the trend score according to a difference of the second time and the last reference time for the content item; and
comparing the trend scores of the content items.

2. The method of claim 1:
respective content items comprising a web resource identified by a uniform resource locator, and
respective references to the content items comprising a message generated by a user of a social network including the uniform resource locator of the web resource.

3. The method of claim 1:
respective content items comprising data objects in a data object library, and
respective references to the content items comprising accesses of the data object by at least one agent.

4. The method of claim 1:
respective content items comprising a location;
respective references to the content items comprising a location reference to the location; and
the instructions configured to, upon detecting the reference to the content item:
compute a generalized location reference including the location reference, and
use the generalized location reference as the reference to the content item.

5. The method of claim 1:
detecting a reference to the content item comprising:
examining a reference to determine whether the reference references a target reference; and
upon determining that the reference references a target reference, using the target reference as the reference to the content item.

6. The method of claim 5:
the device having a reference cache identifying, for respective references, the target reference identified by the reference;
the instructions configured to, upon determining that a reference references a target reference, store in the reference cache the reference and the target reference; and
examining the reference to determine whether the reference references a target reference comprising: determining whether the reference cache includes the reference.

7. The method of claim 1, the content item histogram comprising an array of a reference counts to the content item, respective reference counts indicating a count of references to the content item detected within a reference period having a reference period duration, and at least one reference count representing the reference count within a current reference period.

8. The method of claim 7:
the last reference time indicating a start time of the current reference period; and
incrementing the current reference count comprising:
comparing a reference time of the reference to the last reference time; and
if the reference time exceeds the current reference period by more than the reference period duration:
inserting into the array at least one reference count initialized to zero and representing at least one reference period of the reference period duration since the last reference time, and
updating the last reference time.

9. The method of claim 7:
the content item histogram for a content item comprising at least two arrays of reference counts to the content item, a first array comprising respective reference counts detected within a reference period having a first reference period duration, and a second array comprising respective reference counts detected within a reference period having a second reference period duration that is different from the first reference period duration; and
setting the trend score for the content item comprising: setting the trend score for the content item using the at least two arrays comprising the content item histogram.

10. The method of claim 9, setting the trend score of the content item comprising:
for respective arrays, computing an array trend score; and
setting the trend score as a maximum array trend score among the array trend scores.

11. The method of claim 7:
respective references associated with a reference time indicating a time at which the reference was generated;
incrementing the current reference count of the content item histogram for the content item comprising: incrementing a reference count in the array associated with references having reference times within the reference period of the reference time of the reference; and
setting the last reference time for the content item comprising: setting the last reference time for the content item if the reference time of the reference is later than the last reference time.

12. The method of claim 1, setting the trend score of the content item comprising: computing a change magnitude of recent reference counts to the content item in the content item histogram compared with earlier reference counts to the content item in the content item histogram.

13. The method of claim 1, decaying the trend scores of respective content items comprising:
computing a reference lapse interval comprising at least one reference period having a reference period duration between the second time and the last reference time, and
for respective reference periods of the reference lapse interval, reducing the trend score of the content item by a decay value.

14. The method of claim 1, identifying the trending content items comprising: among the trending content items, identifying a trending content item set of trending content items having highest trend scores, the trending content item set having a trending content item set size.

15. The method of claim 14, decaying the trend scores of respective content items comprising:
between a first content item having a first trend score and a second content item having a second trend score lower than the first trend score, decaying the trend score of the first content item before decaying the trend score of the second content item; and
upon decaying the trend scores of the trending content item set size of content items resulting in higher trend scores than the trend scores of remaining content items, ceasing decaying the trend scores of the content items.

16. The method of claim 1:
identifying the trending content items at the second time performed upon receiving a request from a user to identify trending content items at the second time; and
identifying the trending content items at the second time comprising: presenting to the user the trending content items.

17. The method of claim 16, presenting to the user the trending content items comprising: presenting to the user the trending content items sorted according to the trend scores of the trending content items.

18. The method of claim 1, the instructions configured to, upon detecting a trending content item, notify at least one user regarding the trending content item.

19. A system configured to identify trending content items based on references to the content items, comprising:
a reference counting component configured to, upon detecting a reference to a content item:
if the reference comprises a first detected reference to the content item, initiate a content item histogram for the content item;
increment a current reference count of the content item histogram for the content item;
using the content item histogram, set a trend score for the content item; and
set a last reference time for the content item; and
a trending content item identifying component configured to identify trending content items at a second time by:
for respective content items, decaying the trend score according to a difference of the second time and the last reference time for the content item; and
comparing the trend scores of the content items.

20. A computer-readable medium comprising instructions that, when executed by a processor of a device, identify trending content items respectively comprising a web resource identified by a uniform resource locators based on references to the content items, respective references comprising a message generated by a user of a social network including the uniform resource locator of the web resource, the device having a reference cache identifying, for respective references, a target reference identified by the reference, by:
upon detecting a reference to a content item:
examining the reference to determine whether the reference references a target reference;
upon determining that the reference references a target reference:
examining the reference cache to determine whether the reference cache includes the reference;
upon determining that the reference cache includes the reference, identifying the target reference associated with the reference in the reference cache; and
upon determining that the reference cache does not include the reference:
identifying the target reference referenced by the reference, and
storing in the reference cache the reference and the target reference;
if the reference comprises a first detected reference to the content item, initiating a content item histogram for the content item, the content item histogram comprising an array of a reference counts to the content item, respective reference counts indicating a count of references to the content item detected within a reference period having a reference period duration, and at least one reference count representing the reference count within a current reference period;
incrementing a current reference count of the content item histogram for the content item by:
comparing a reference time of the reference to the last reference time; and
if the reference time exceeds the current reference period by more than the reference period duration:
inserting into the array at least one reference count initialized to zero and representing at least one reference period of the reference period duration since the last reference time, and
updating a last reference time for the content item; and
using the content item histogram, setting a trend score for the content item by computing a change magnitude of recent reference counts to the content item in the content item histogram compared with earlier reference counts to the content item in the content item histogram; and
identifying trending content items at a second time by:
for respective content items, decaying the trend score according to a difference of the second time and the last reference time for the content item by:
computing a reference lapse interval comprising at least one reference period having a reference period duration between the second time and the last reference time, and
for respective reference periods of the reference lapse interval, reducing the trend score of the content item by a decay value;
comparing the trend scores of the content items by, among the trending content items, identifying a trending content item set of trending content items having highest trend scores, the trending content item set having a trending content item set size; and
presenting to a user the trending content items sorted according to the trend scores of the trending content items.
